(19) United States
(12) Patent Application Publication
(10) Pub. No.: US 2009/0044147 A1
(43) Pub. Date: Feb. 12, 2009

(54) SYSTEM AND METHOD FOR PRESENTING DYNAMIC ADVERTISEMENTS ON WEB PAGES

(76) Inventor: Marc Alringer, San Diego, CA (US)

Correspondence Address: PERKINS COIE LLP, P.O. BOX 1208, SEATTLE, WA, 98111-1208, US

(21) Appl. No.: 12/188,009

(22) Filed: Aug. 7, 2008

Related U.S. Application Data
(60) Provisional application No. 60/954,776, filed on Aug. 8, 2007.

(51) Int. Cl. G06F 3/048

(52) U.S. Cl. 715/810

(57) ABSTRACT

A system and method are described for presenting a list of performable actions associated with a dynamic advertisement on a web page, and for performing the actions upon a user input.

### RELATED APPLICATIONS

This application claims the benefit of priority to U.S. Provisional Appln. Ser. No. 60/954,776 filed Aug. 7, 2007 entitled “System and Method For Presenting Dynamic Advertisements On Web Pages,” which is incorporated herein by reference in its entirety.

### BACKGROUND

Many web pages present advertisements when displaying content. Typically, these advertisements are one-dimensional and selecting the advertisement leads a user to a different webpage associated with the advertisement. For example, a webpage may present a number of different banner ads each associated with html code that acts to link the user with another webpage when the banner ad is clicked by the user. In addition, webpage providers may rotate displayed banner ads in order to present the user or users with different and multiple advertisements during a user session within the page.

At times, a user may be interested in the advertisement (or in the company, product, or service associated with the advertisement), but may also be otherwise occupied. For example, a user may be playing an online game within a webpage displaying advertisements. The user may wish to click on one of the displayed advertisements but may choose not to because they do not wish to be transferred to another webpage or lose track of what they are doing within the game. They may subsequently forget about the advertisement and/or not pursue the content of the advertisement at a later time. The advertiser presenting the advertisement may lose a potential client or customer once the advertisement is no longer displayed on the webpage.

These and other problems exist with respect to presenting one dimensional advertisements on web pages.

### BRIEF DESCRIPTION OF THE DRAWINGS

FIG. 1 is a block diagram illustrating a networked environment displaying advertisements on web pages.

FIG. 2 is a flow diagram illustrating a routine for performing an action based on a multi-dimensional advertisement displayed on a webpage.

FIGS. 3A-3B illustrate displayed multi-dimensional advertisements.

FIG. 4 is a flow diagram illustrating a routine for storing advertisements for a user.

FIG. 5 illustrates a webpage displaying multiple advertisements saved by a user.

### DETAILED DESCRIPTION

A system and method for presenting multi-dimensional advertisements on web pages is described. In some examples, the system presents performable actions to the user along with the advertisement. The system may present a list of choices within the advertisements (such as part of the advertisement), or may present a list of choices when a user hovers a cursor over the advertisement or selects the advertisement (such as by clicking on the advertisement).

In some examples, the system receives a request from a user to save a displayed advertisement, and saves the advertisement, or information related to the advertisement, to a database or index related to the user. The system may then provide a separate or integrated display that shows the saved advertisements to the user along with the webpage the user is viewing.

Systems and modules described herein may comprise software, firmware, hardware, or any combination(s) of software, firmware, or hardware suitable for the purposes described herein. Software and other modules may reside on servers, workstations, personal computers, computerized tablets, PDAs, cell phones and other mobile devices, and other devices suitable for the purposes described herein. In other words, the software and other modules described herein may be executed by a general-purpose computer, e.g., a server computer, wireless device or personal computer. Those skilled in the relevant art will appreciate that aspects of the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor. Furthermore, aspects of the system can be embodied in a special purpose computer or data processor that is specifically programmed, configured, or constructed to perform one or more of the computer-executable instructions explained in detail herein.

Software and other modules may be accessible via local memory, via a network, via a browser or other application in an ASP context, or via other means suitable for the purposes described herein. Examples of the technology can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

Examples of the technology may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

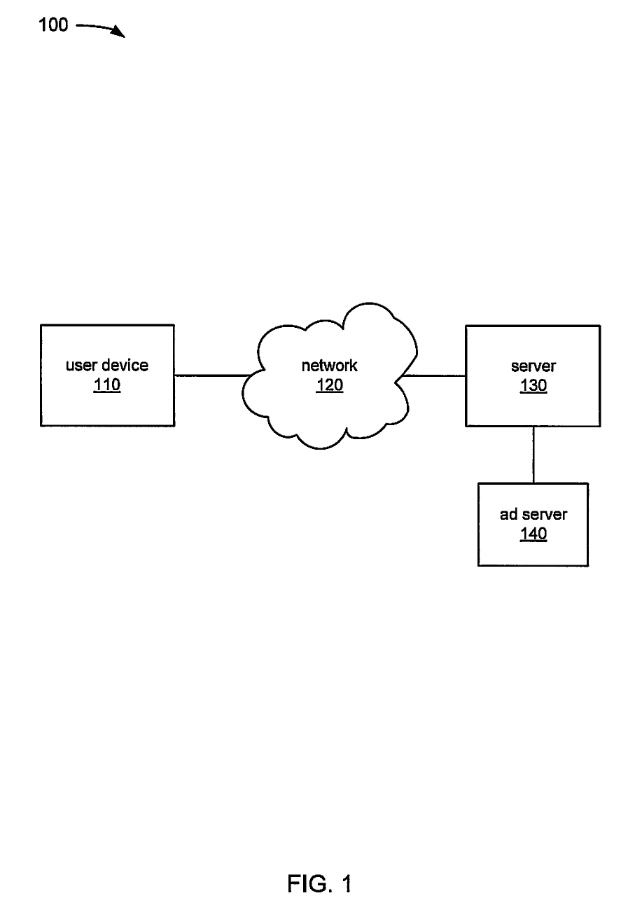

FIG. 1 is a block diagram illustrating a networked environment 100 displaying advertisements on web pages. The networked environment includes a user device 110 such as a user computer, mobile device, and so on. User device 110 is connected to a server 130, such as a server computer, over a network 120, such as the internet. The server computer 130 may provide content over the network 120 to the user device 110, such as content displayed on a web browser contained by the user device. The server 130 may communicate with an advertisement server 140 or other component that provides advertisements to the server computer 130 to be presented to a user at the user device 110, such as within a displayed webpage. For example, the advertisement component 140 may store the multi-actionable advertisements described herein, may store an index, database, or data structure that tracks and stores advertisements for a user, or other information related to providing actionable advertisements to the user at the user device 110. Alternatively, the user device 110 may include a database or other data structure that tracks user requests and/or stored advertisements.

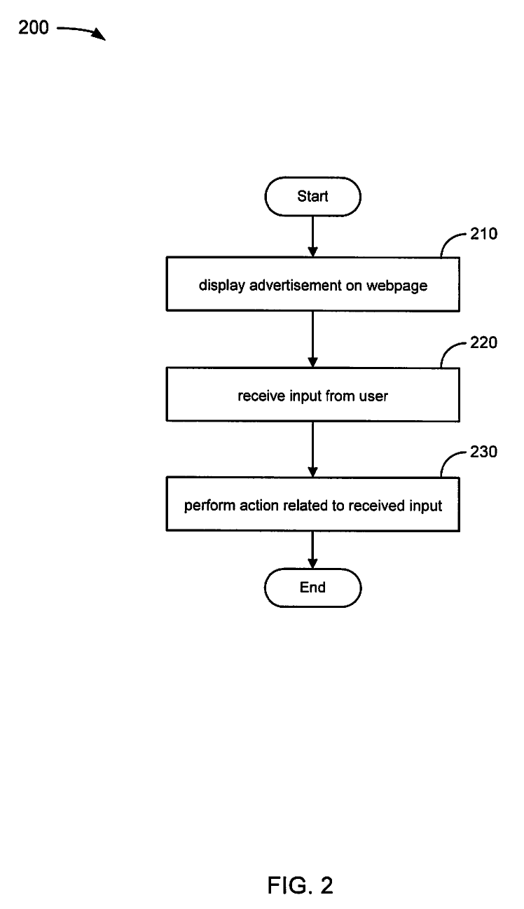

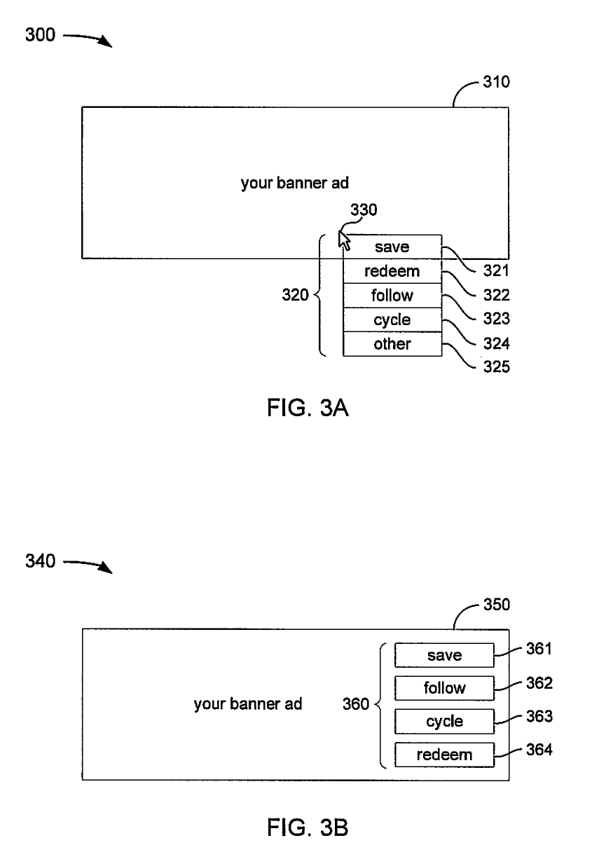

As described herein, presented advertisements may facilitate the system performing one or more of multiple actions based on a presented advertisement. Referring to FIG. 2, a flow diagram illustrating a routine 200 for performing an action based on a multi-dimensional advertisement displayed on a webpage is shown. In step 210, the system displays an advertisement on a webpage. The displayed advertisement may be a banner advertisement, an interstitial advertisement, a floating advertisement, an expanding advertisement, a wallpaper advertisement, a trick banner, a pop-up advertisement, or other online advertisement types. In some cases, the displayed advertisement presents the user with a number of selectable choices within the advertisement. In some cases, the displayed advertisement displays a list or menu of selectable choices upon receiving a request from a user, such as when a user moves a cursor over the advertisement or clicks on the advertisement. The system may present the list over the advertisement, on top of the advertisement, or may dynamically change the advertisement to indicate the selectable choices. Examples of presented advertisements will be described with respect to FIGS. 3A-3B.

In step 220, the system receives input from the user. For example, a user may select a choice from a presented list of choices by clicking on a text button or other graphically displayed object. In step 230, the system performs an action related to the received input. For example, when the user clicks a text button related to saving an advertisement for later viewing (step 220), the system stores the advertisement (and related links and information) in a database or other storage area reserved for the user.

As described herein, in some examples the system displays selectable choices along with a displayed advertisement. Referring to FIG. 3A, a displayed advertisement 300 presented on a representative computer display or web page will now be described. The web pages and presented advertisements of FIGS. 3A-3B and screens discussed herein may be implemented in C++ or as web pages under XML (Extensible Markup Language), HTML (HyperText Markup Language) or any other scripts or methods of creating displayable data, such as the Wireless Access Protocol (“WAP”). The screens or web pages provide facilities to receive input data, such as a form with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats.

The advertisement includes a content portion 310 of the advertisement. When a user moves a cursor 330 over the content portion 310, a user selectable menu 320 appears. The menu 320 may include a number of different choices that correspond to performable actions. For example, the menu 320 includes a save choice 321, a redeem choice 322, a follow choice 323, a cycle choice 324, and/or other choices. The system may then perform actions related to the choices 321-325. For example,

Selecting the save choice 321 may cause the system to save the advertisement for later viewing by the user,

Selecting the redeem choice 322 may cause the system to present a coupon related to the advertisement to the user,

Selecting the follow choice 323 may cause the system to send the user to a webpage or other hosted site related to the advertisement, and

Selecting the cycle choice 324 may cause the system to present a different advertisement to the user, such as an advertisement related to the presented advertisement.

In addition to performing actions related to the specific presented advertisement, the system may enable a user to quickly cycle through other advertisements that may contain information desired by the user. The cycling may facilitate the webpage provider to present many targeted advertisements to a user, increasing revenues from sponsors due to an increased number of displayed advertisements and/or a targeted presentation of advertising content.

In some examples, the system displays selectable choices within a displayed advertisement. Referring to FIG. 3B, a presented advertisement 340 containing various actionable choices within the advertisement is shown. The advertisement includes a content portion 350 and various choices 360, including a save choice 361, a follow choice 362, a cycle choice 363, a redeem choice 364, and so on. The choices are similar to those described herein, and are related to actions performed by the system based on the advertisement. For example, upon selecting one of the choices 360 displayed in advertisement 340, a user may be able to obtain a coupon, save an advertisement for later viewing, visit a website associated with a sponsor of the advertisement, purchase a product, and so on.

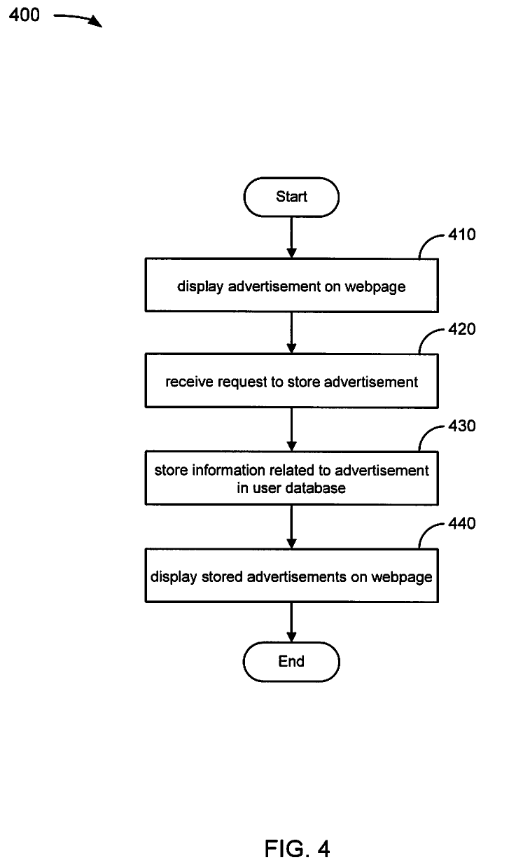

In some examples, the system facilitates the performed action of saving an advertisement for later viewing by a user. Referring to FIG. 4, a flow diagram illustrating a routine 400 for storing advertisements for a user is shown. In step 410, the system displays an advertisement on a webpage, such as the advertisements 300 or 340. In step 420, the system receives a request from the user to store the advertisement. For example, the system receives an input from the user via a selectable choice, or the system queries the user to provide input about the advertisement.

In step 430, the system stores information related to the advertisement in a user database. The system may store the advertisement as presented, may store a link to the advertisement, may store other information or content about the advertisement, and so on. For example, in some cases the system may store the advertisement in a manner different than originally presented in order to facilitate the user viewing the advertisement at a later time or to facilitate storage/retrieval of a saved advertisement.

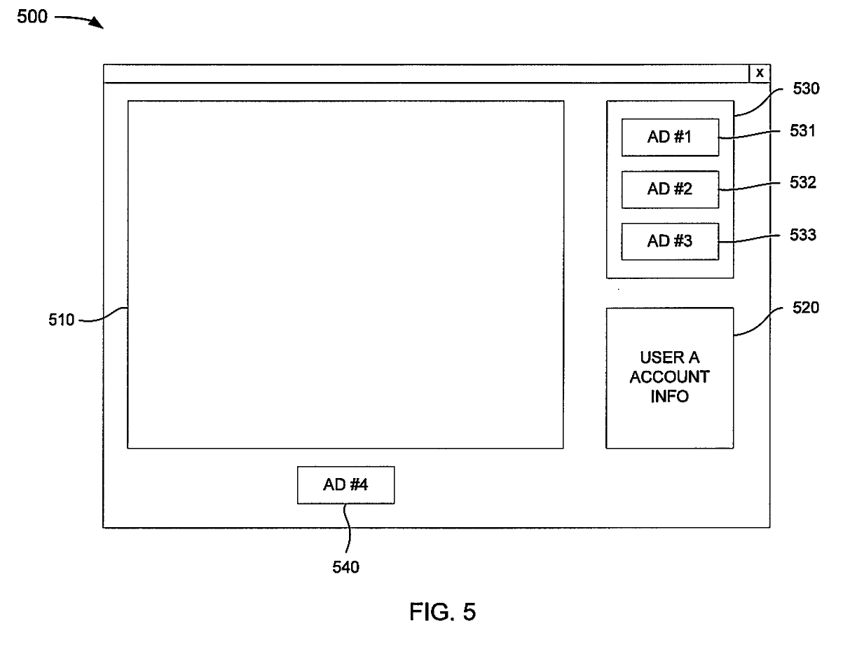

In step 440, the system optionally displays the stored advertisements on the webpage. For example, a webpage may include a section that links to and presents stored advertisements for selection by the user. Referring to FIG. 5, a screen illustrating a webpage 500 displaying multiple advertisements saved by a user is shown. The webpage 500 includes a content section 510, a user section 520, and a stored advertisements section 530 that includes a number of different stored advertisements 531-533. Additionally, the webpage 500 includes a newly presented advertisement 540.

The stored advertisements section 530 presents advertisements selected by the user to be stored by the system and viewed at a later time. In some examples, the system presents these advertisements while the user is playing a game within display 510, such as an online card game or online board game. The user, preoccupied by the game in display 510, may notice a displayed advertisement, but be unable to avert his/her attention from the game and to the advertisement. However, the system enables the user to simply save the advertisement for later viewing, such as in display 530. Thus, the system enables a user to view and/or respond to advertisements at times more advantageous to the user, regardless of when they are presented to the user. As a result, advertisements may deliver higher click through rates and user views, among other benefits.

The above detailed description of examples of the technology is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the system described above. The elements and acts of the various embodiments described above can be combined to provide further examples. Any patents and applications and other references noted above, including any that may be listed in accompanying filing papers, are incorporated herein by reference. Aspects of the system can be modified, if necessary, to employ the systems, functions, and concepts of the various references described above to provide yet further examples of the technology.

From the foregoing, it will be appreciated that specific embodiments of the system have been described herein for purposes of illustration, but that various modifications may be made without deviating from the spirit and scope of the system. Accordingly, the system is not limited except as by the appended claims.

What is claimed is:

1. A method comprising:
displaying a dynamic advertisement on a screen, wherein the dynamic advertisement is configured to provide at least one selectable choice associated with an action; and
performing the action associated with the selectable choice upon receiving a first user input related to the selectable choice.

2. The method of claim 1, wherein the screen is a webpage.

3. The method of claim 1, wherein the at least one selectable choice is presented along with the dynamic advertisement.

4. The method of claim 1, wherein the at least one selectable choice is displayed upon a user request.

5. The method of claim 4, wherein the dynamic advertisement is dynamically changed to accommodate the at least one selectable choice.

6. The method of claim 4, wherein said user request includes moving a cursor over the dynamic advertisement.

7. The method of claim 4, wherein said user request includes selecting the dynamic advertisement.

8. The method of claim 1, wherein the selectable choice is a graphically displayed object.

9. The method of claim 1, wherein the selectable choice is a text button.

10. The method of claim 1, wherein the action enables a user to save the first advertisement for later viewing.

11. The method of claim 10 further comprising storing information associated with the dynamic advertisement in a user database upon said first user input.

12. The method of claim 11 further comprising presenting said information upon a second user input.

13. The method of claim 1, wherein the action enables the user to redeem a coupon related to the dynamic advertisement.

14. The method of claim 1, wherein the action enables the user to go to a webpage related to the dynamic advertisement.

15. The method of claim 1, wherein the action enables the user to display a second advertisement.

16. The method of claim 15, wherein the second advertisement is related to the first advertisement.

17. A machine-readable medium embodying instructions, the instructions, which when executed, causing a machine to perform a method comprising:
displaying a dynamic advertisement on a screen, wherein the dynamic advertisement is configured to provide at least one selectable choice associated with an action; and
performing the action associated with the selectable choice upon receiving a first user input related to the selectable choice.

18. A method for providing dynamic advertisement on a webpage, the method comprising:
displaying the dynamic advertisement on the webpage, wherein the dynamic advertisement is configured to provide a user selectable list including one or more choices corresponding to performable actions;
storing information associated with the dynamic advertisement in a user database upon a first user input associated with one of the choices; and
displaying said information upon a second user input.

19. The method of claim 18, wherein the user database is located on a remote server.

20. The method of claim 18, wherein the user database is located on a local user device.

21. The method of claim 18, wherein said information is displayed in a window, wherein said window is integrated in the webpage.

22. The method of claim 18, wherein said information is displayed in a window, wherein said window is separate from the webpage.

23. The method of claim 18 further comprising displaying the dynamic advertisement associated with the information upon a third user input.

24. A system comprising:
a user device configured to display a dynamic advertisement;
a network; and
a server configured to store information relating to the dynamic advertisement, wherein the server is connected with the user device through the network;
wherein the dynamic advertisement is configured to provide a user selectable list including one or more choices corresponding to performable actions;
wherein, in operation, a user of the user device selects one of the one or more choices, wherein the user device performs an action associated with the one or more choices.
